(19) United States
(12) Patent Application Publication
(10) Pub. No.: US 2003/0057272 A1
(43) Pub. Date: Mar. 27, 2003

(54) Method for protecting against theft of a pin number in (a) multi-application smart card(s) and chip card(s) implementing said method

(76) Inventors: Christophe Bidan, Thorigne-Fouillard (FR); Pierre Girard, La Ciotat (FR)

Correspondence Address: BURNS DOANE SWECKER & MATHIS L L P, POST OFFICE BOX 1404, ALEXANDRIA, VA, 22313-1404, US

(21) Appl. No.: 10/181,053

(22) PCT Filed: Jan. 12, 2001
(86) PCT No.: PCT/FR01/00110

(30) Foreign Application Priority Data
Jan. 14, 2000 (FR) 00 00488

(51) Int. Cl. G06K 5/00

(52) U.S. Cl. 235/380

(57) ABSTRACT

The invention relates to a method for protecting against theft of a PIN number for (a) multi-application smart card(s) by applications which do not have any outside access. The inventive method consists in detecting operations for the verification of the PIN number by means of one or more applications devoid of access outside said card by counting the number of unsuccessful attempts irrespective of the application and by blocking the operation of said card when the number of subsequently attempted operations reaches a given threshold value.

The invention relates to a method for protecting against the theft of the secret code in multiapplication chip cards. It also relates to chip cards using the said method.

Multiapplication chip cards means cards containing one or more integrated-circuit chips, the said cards being intended to be able to execute various application programs loaded or downloaded during the life of the card.

Amongst the solutions of multiapplication cards existing at the present time, we can indicate “JavaCard” defined/specified by Sun or “SmartCard for Windows” defined/specified by Microsoft.

To simplify, applications will be spoken of hereinafter in order to designate application programs (or Applet in English terminology).

Secret code means the personal identification number of the holder of the card, which is also referred to as the PIN number (Personal Identification Number).

For reasons of compatibility with the chip cards which support only one application, and simplicity in the use of the card, multiapplication chip cards generally have only one global PIN number for all applications. Thus the OP specification defined by VISA, which currently acts as a standard for the loading/downloading and the internal management of applications on multiapplication chip cards, defines a unique secret code for all resident and future applications of the card.

The problem raised by the applicant in the case of a multiapplication card stems from the fact that the card is designed to be able to load or download new applications throughout its life. In principle this is an advantage, but in practice this characteristic makes the card vulnerable, since malevolent applications may be loaded with other applications in a manner which is transparent to the holder. This is therefore an open door to such applications which of course in practice will seek to discover the secret code of the card.

Following this observation, the applicant has identified an attack making it possible to find the PIN number of the card:

This attack assumes the existence of a malevolent application which does not have access to a terminal for transaction with the card, that is to say is not designed to dialogue with the outside.

An application does not have access to a terminal provided that there do not exist any terminals using a protocol making it possible to dialogue directly with this application. Such applications can nevertheless be executed within the card, since they offer/supply services to the other applications of the card. It is possible to cite for example loyalty applications, which are applications designed for counting loyalty points.

Here is then the procedure followed during this attack by means of an application which cannot dialogue with the outside.

In fact the application uses the logical interface offered by the operating system (or by a dedicated application) and making it possible to verify the secret code. Thus, for VOP, the OP implementation for “JavaCard”, this interface is the operation “verify PIN”.

An application able to dialogue with the outside and wishing to verify the identifier of the bearer commences with requesting the user to enter his secret code by displaying a message on the screen of the terminal in which the chip card is inserted. Next the application uses the interface provided by the operating system (or by the dedicated application) in order to verify that the value entered by the user is identical to the value of the secret code of the card. If such is the case, the operating system (or the application responsible for verifying the code) responds by affirmation; or by negation in the contrary case.

Since the secret code verification interface is accessible to all the applications of the card, a malevolent application can trigger the execution of this operation and thus have various values tested until a positive response is obtained indicating that the secret code presented is valid.

A malevolent application can therefore use the secret code verification operation (verify PIN for VOP) and thus try various values for the code (0, 01, 02, 03, . . . 9999).

To prevent an excessively large number of values being tested, the card generally has a ratification counter which blocks its operation at the end of a given number of incorrect codes. In practice this number is generally 3.

It is therefore possible for a malevolent application to successively present two code values (or more generally n−1 if the number of incorrect codes causing blockage of the card is n), and if the code is wrong twice, that is to say the response to the verification of the secret code is negative, the ratification counter will be incremented by two, the application obviously being designed to stop the tests and wait until this counter is reinitialised by an entry of the correct code by the user.

This is because the triggering by the user of an application dialogue dialoguing with the outside uses the secret code verification procedure as previously described. The secret code is requested of the user, who enters it from the terminal keypad. The verification procedure is implemented, and if the user has not made a mistake, the ratification counter which was at 2 because of the attempts of the malevolent application is reset to zero. Thus the malevolent application can recommence tests.

In the patent literature, two documents come close to the said invention. These are the documents:

D1: U.S. Pat. No. 4,879,645 of Oazaki Hiroshi, November 1999;

D2: U.S. Pat. No. 4,983,816 of Iijima Yasuo, November 1991.

Document D1 relates to a data processing device guaranteeing a high level of security for the stored programs. More specifically, this document applies to the protection of the programs stored in the microprocessor of a chip card. This document essentially seeks to prevent malevolent actions on the part of the user, an attack described in the text, seeking to discover a secret algorithm stored in the card. This is because the user possesses the secret code of the card and can therefore make sensitive programs function millions of times without blocking the card and thus discover the secret algorithms of certain programs. This document proposes to limit the number of successive invocations of a specific program (whose algorithm must remain secret) by limiting the number of invocations possible, by extending the response time, by preventing the continuous functioning of the program for example.

Document D2 relates to a chip card having several card identification codes (PIN), at least two codes showing the same indicator. When an erroneous code is added, a counter is incremented. A system of double counters is proposed, a resetting by a correct entry of the code or by a cutting of the power supply and another never entered at zero. No mention is made in this document of a chip card having means of detecting secret code verification operations by an application not having access to the outside.

However, neither of these two documents mentions the functioning of an application without access to the outside of the card with a view to the discovery of the secret code of the said card.

The purpose of the present invention is to remedy these problems.

The subject matter of the present invention is a method for protecting against the theft of the secret code for multiapplication chip cards, principally characterised in that it consists in detecting operations of verifying the secret code by one or more applications which do not have access to the outside of the card and to block the functioning of the said card or of the said application or applications when the number of operations detected has reached a predetermined threshold value.

According to one characteristic of the invention, the detection of secret code verification operations comprises the triggering of a ratification counter for counting unsuccessful secret code trials.

According to a first embodiment, the method consists in using two ratification counters, a first counter for counting the unsuccessful attempts, the said counter being reset to zero when the holder presents a correct secret code before having reached a predetermined maximum number of possible presentations, the functioning of the card being blocked in the contrary case, and in that it consists in incrementing a second counter each time the first counter approaches the maximum value and blocking the functioning of the card or of the application when the value of this second counter reaches the predetermined threshold value.

According to another embodiment, the method consists in using one ratification counter per application, each counter being able to count up the unsuccessful secret code trials relating to each application liable to be used by the card, the blockage of the functioning of the card being caused as soon as one of the counters has reached a predetermined threshold value for the said counter.

Another subject matter of the invention is a multiapplication chip card, principally characterised in that it has means of detecting secret code verification operations by an application not having access to the outside and means of blocking its functioning when the number of verification operations has reached a predetermined threshold value.

The means of detecting secret code verification operations comprise at least two ratification counters for the counting of unsuccessful secret code trials.

According to a first embodiment, the counting means comprise two ratification counters, a first counter for counting up the unsuccessful attempts, the said counter being reset to zero when the holder presents a correct secret code before having reached a predetermined maximum number of possible presentations, the functioning of the card being blocked in the contrary case, and a second counter incremented each time the first counter approaches the maximum value and which is used by the blocking means for blocking the functioning of the card when the value of this counter reaches a predetermined maximum value.

According to another embodiment the ratification counting means comprise one counter for each application, each counter being able to count up the unsuccessful secret code trials relating to each application liable to be used by the card, the blocking of the functioning of the card or of the application being caused as soon as one of the counters has reached a predetermined threshold value for the said counter.

Other particularities and advantages of the invention will emerge clearly from a reading of the description given below with regard to the drawings, in which:

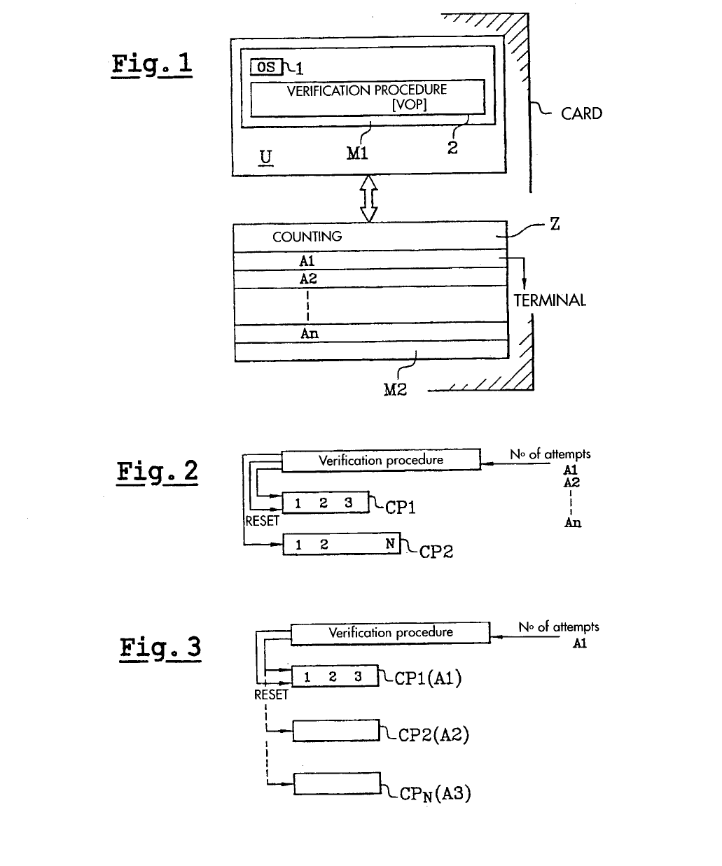

FIG. 1 depicts the functional diagram of a multiapplication chip card,

FIG. 2 depicts the functional diagram of a first embodiment,

FIG. 3 depicts the functional diagram of a second embodiment.

A multiapplication chip card has been shown schematically in FIG. 1 in order to illustrate the different elements participating in the implementation of the method according to the invention.

A first solution proposed according to the method consists in using two ratification counters, a first one for counting all the faulty keyings of the secret code whatever the application, the said counter being reset to zero when there is a correct presentation of the secret code before having reached a predetermined maximum number of possible presentations, the functioning of the card being blocked in the contrary case, the second counter for counting the number of times the first counter exceeds the value of a predetermined threshold, the said counter not being reset to zero after presentation of a correct code.

A second solution consists in using one ratification counter per application A1, A2, . . . , An.

In order to understand the invention better it is stated that a chip card has a processing unit U provided with a program memory in which there is the operating system of the card as well as applications able to extend the functionalities provided by the operating system by proposing services to the other applications by means of their interface, for example an application dedicated to the verification of the secret code.

The various application programs A1, A2, An can be situated in this same program memory M1 or in another program memory M2 which will then be provided for this purpose so as to be able to load new applications during the life of the card. In this case the memory will be an electrically erasable memory (of the EEPROM type).

An area Z for the counting of unsuccessful attempts can be provided in this memory M2.

According to a first embodiment illustrated by FIG. 2, the detection of unsuccessful attempts made by an application which does not have access to the outside is effected by means of two counters CP1 and CP2.

At the end of the verification performed by the verification procedure launched by any one of the applications, and in the presence of a wrong secret code, the counter CP1 is incremented. Thus, when it is a case of an application which does not have access to the outside, the secret code provided for verification can come only from this application which is seeking to make attempts to discover the secret code.

In the case of applications having access to the outside, the code used for the verification of the secret code is requested of the card holder by the application. In principle the holder of a card will make a mistake less often than a malevolent application which is making attempts to discover the secret code.

The invention proposes to use a second-order ratification counter CP2. This consists in counting not the number of times that a wrong code has been presented, but the number of times that the value of the first counter CP1 is close to the value which will cause a blocking of the functioning.

In a practical fashion, the first counter CP1 is incremented each time the code presented is wrong, whether it is a case of a presentation made by the card holder or by a malevolent application. The maximum value of this counter is for example three (three possible attempts). If the correct secret code is entered during these three attempts, this counter CP1 is reset to zero. When this counter has a value close to the maximum value, that is to say two in this example, the second counter CP2 is incremented.

Thus a count is made with the second counter each time the first ratification counter passes to 2 (if the blocking value is for example 3). This second counter is not reset to zero and, when its value reaches a predetermined threshold value N′, the system blocks the functioning of the card.

The threshold fixed for this second counter can be chosen according to the length of the secret code. The longer the code, the more the users will have a tendency to make a mistake in keying it in, and in this case a higher threshold value will be chosen than in the case where the code is short (4 digits for example).

The second solution proposed and illustrated by the diagram in FIG. 3 consists in providing one ratification counter per application CP1 for A1, CP2 for A2, . . . , CPn for An (for n applications). The secret code remains global, that is to say it is the same for all the applications, but one counter is associated with each application.

The counter relating to an application will consequently be incremented each time a wrong secret code is entered. When the correct secret code is entered the counter of the application is reset to zero. When the value of the counter reaches a maximum value (for example 3) the functioning of the card or of the application is blocked. This mechanism is the same for all the applications present in the card. When a new application is loaded in the card the operating system associates a counter with this new application.

Each application is recognised by the operating system by virtue of the identification field AID (Applet Identifier).

With each application identification, the operating system associates the corresponding ratification counter and increments it for each wrong secret code presentation. In the case of a malevolent application not having access to the outside performing unsuccessful secret code trials, it is this which supplies the code.

For other applications, it is the card user who enters his code on the terminal keypad.

Thus a malevolent application cannot present a wrong secret code more than three times (if the counter is fixed at three).

1. A method for protecting against the theft of the secret code for multiapplication chip cards (A1, A2, . . . An), consisting in detecting secret code verification operations by one or more applications not having access to the outside of the card and blocking the functioning of the said card or of the said applications when the number of operations detected has reached a predetermined threshold value
characterised in that it consists in using, for the said detection of a secret code verification operation, two ratification counters (CP1, CP2), a first counter (CP1) for counting up the unsuccessful attempts, the said counter being reset to zero when the holder presents a correct secret code before having reached a predetermined maximum number of possible presentations, the functioning of the card being blocked in the contrary case, and in that it consists in incrementing a second counter (CP2) each time the first counter (CP1) approaches the maximum value and blocking the functioning of the card when the value of this second counter reaches the predetermined threshold value.

2. A method against the theft of the secret code according to claim 1, characterised in that it consists in using one ratification counter (CP1, CP2) per application (A1, A2, . . . , An), each counter (CP1, CP2) being able to count up the unsuccessful secret code trials relating to each application (A1, A2, . . . , An) liable to be used by the card, the blocking of the functioning of the card being caused as soon as one of the counters (CP1, CP2) has reached a predetermined threshold value for the said counter.

3. A multiapplication chip card, having means of detecting secret code verification operations for an application (A1, A2, . . . , An) not having access to the outside and means of blocking its functioning when the number of verification operations has reached a predetermined threshold value, characterised in that the means of detecting secret code verification operations comprise at least two ratification counters (CP1, CP2) for counting unsuccessful secret code trials.

4. A multiapplication chip card according to claim 3, characterised in that the first counter (CP1) is able to count up the unsuccessful attempts, the said counter (CP1) being reset to zero when the holder presents a correct secret code before having reached a predetermined maximum number of possible presentations, the functioning of the card being blocked in the contrary case, and the second counter (CP2) is incremented each time the first counter (CP1) approaches the maximum value and which is used by the blocking means for blocking the functioning of the card when the value of this counter (CP1) reaches a predetermined maximum value.

5. A multiapplication chip card according to claim 3, characterised in that the ratification counting means comprise one counter (CP1, CP2) for each application (A1, A2, . . . An), each counter (CP1, CP2) being able to count up the unsuccessful secret code trials relating to each application (A1, A2, . . . , An) liable to be used by the card, the blocking of the functioning of the card or of the application being caused as soon as one of the counters (CP1, CP2) has reached a predetermined threshold value for the said counter (CP1, CP2).
